(19) United States
(12) Patent Application Publication
(10) Pub. No.: US 2023/0182448 A1
(43) Pub. Date: Jun. 15, 2023

(54) POLYMER FILM

(71) Applicant: CHANG CHUN PETROCHEMICAL CO., LTD., Taipei City (TW)

(72) Inventor: Tzu-Jung Huang, Taipei City (TW)

(21) Appl. No.: 17/853,601

(22) Filed: Jun. 29, 2022

(30) Foreign Application Priority Data
Dec. 10, 2021 (CN) 202111504245.4
Dec. 10, 2021 (TW) 110146369

(51) Int. Cl. B32B 17/10; B32B 27/30; B32B 27/22; B32B 27/08; B32B 7/02

(52) U.S. Cl. CPC B32B 17/10761; B32B 27/306; B32B 27/22; B32B 27/08; B32B 7/02; B32B 17/10036; B32B 17/10605; B32B 2307/102; B32B 2307/732

(57) ABSTRACT

The present disclosure relates to a polymer film comprising a polyvinyl acetal resin and a plasticizer, wherein the polymer film comprises at least one first layer and at least one second layer, and the loss factor of the first layer and the loss factor the second layer are different; furthermore, the ratio of the loss factor of the first layer to that of the second layer is 1.30 to 3.12. The polymer film provided herein has an improved sound insulation effect.

### BACKGROUND OF THE INVENTION

### 1. Technical Field

The present invention relates mainly to a polymer film and more particularly to a polymer film suitable for use as an intermediate film in laminated glass.

### 2. Description of Related Art

Laminated glass (also known as sandwich glass) is a type of safety glass that can stay in one piece when shattered. Laminated glass includes a film sandwiched between two or more layers of glass, and the film is generally made from polyvinyl butyral resin (PVB) or ethylene-vinyl acetate (EVA). The film can keep the glass layers bonded together even when the laminated glass is broken, and the film is so strong that it prevents the laminated glass from breaking into large sharp pieces. A typical “spider web” crack pattern, however, tends to result when an impact force acting on the laminated glass is not great enough to puncture the glass.

In addition to having the safety feature stated above, laminated glass can be adapted for soundproofing. Compared with a single glass window pane of the same thickness, laminated glass is superior in sound wave attenuation thanks to the film in the glass. A PVB film having a multilayer structure may be used as the film in soundproof laminated glass in order to produce a better soundproofing effect.

More specifically, the soundproofing effect of the aforesaid film is believed to hinge directly on the glass transition temperature (Tg) of the film. The so-called glass transition temperature refers to a temperature at which a substance is convertible between a glass state, in which the substance has low fluidity, and a highly elastic state, in which the substance has high fluidity and is soft. Generally, the lower the glass transition temperature of a film, the more the film tends to be highly fluid and soft, and hence the better the soundproofing effect of the film, as would be determined by a person of ordinary skill in the art.

### BRIEF SUMMARY OF THE INVENTION

This part of the specification aims to provide a brief summary of the invention so as to enable a basic understanding of the invention. The brief summary of the invention is neither a complete description of the invention nor intended to point out the important or key elements of certain embodiments of the invention or define the scope of the invention.

The inventor of the present invention has found that the conventional use of the glass transition temperature of a film as a major criterion for the soundproofing effect of the film is actually in doubt. It is not always true that the lower the glass transition temperature of a film, the better the soundproofing effect.

The inventor holds that a film having a multilayer structure can provide sound insulation owing to the fact that the difference between the materials of the different layers can bring about effective reduction of the vibrations caused by sound propagating through the film. In particular, the soundproofing effect and the uniformity of the entire film structure are related to the difference between the damping characteristics of the different layers. More specifically, the viscoelasticity of the aforesaid film is regarded as an important parameter that determines the soundproofing effect. Viscoelasticity is a combination of viscosity and elasticity, i.e., a combination of the flow characteristics of a viscous fluid and an elastic fluid. The difference in viscoelasticity in a multilayer structure allows sound passing therethrough to be subjected to interference of the mediums so that the sound waves are converted into stored energy and expended energy associated with molecular motion in the film materials to reduce the volume of the sound. When there is an appropriate difference between the loss factors (tanδ) of the interlayer(s) and protective layer(s) of a multilayer film, sound passing through the film can be more effectively used by the film materials and therefore better reduced.

In addition, the aforesaid film typically includes a plasticizer, and the inventor has found that the soundproofing effect and film-forming properties of a film may be related to the compatibility of the film with the plasticizer used therein. For example, if the resins in a multilayer film cannot absorb a sufficient amount of plasticizer, the viscoelasticity of a certain layer will not be effectively distinguishable from that of another; consequently, sound propagating through the film will not be effectively absorbed by the film materials, and a poor soundproofing effect results. Moreover, if the resins cannot absorb the plasticizer sufficiently, the unabsorbed plasticizer will leak out such that the film has undesirable film-forming properties. Furthermore, the inventor holds that a multilayer film with low compatibility with its plasticizer may result from too great a difference between the loss factors of its interlayer(s) and protective layer(s) (i.e., too great or too small a ratio between the loss factors) or too small a hydroxyl group content of the film.

Accordingly, one aspect of the present invention provides a polymer film, comprising a polyvinyl acetal resin and a plasticizer; wherein: the polymer film comprises at least one first layer and at least one second layer, and the first layer has a loss factor different from a loss factor of the second layer; and a ratio of the loss factor of the first layer to the loss factor of the second layer ranges from 1.30 to 3.12.

According to an embodiment of the present invention, the plasticizer in the first layer is in an amount of 50 to 90 parts by weight while the polyvinyl acetal resin in the first layer is in an amount of 100 parts by weight.

According to an embodiment of the present invention, the polyvinyl acetal resin in the first layer has a hydroxyl group content greater than 16.0 mol % and less than 30.6 mol %.

According to an embodiment of the present invention, the polyvinyl acetal resin in the first layer has a degree of polymerization greater than 1750 and less than 3850.

According to an embodiment of the present invention, the polyvinyl acetal resin in the first layer has a degree of acetylation less than 20 mol %.

According to one embodiment of the present invention, the first layer has a glass transition temperature ranging from −7° C. to 6° C.

According to an embodiment of the present invention, the loss factor of the first layer ranges from 0.70 to 1.38.

According to an embodiment of the present invention, the plasticizer in the second layer is in an amount of 30 to 60 parts by weight while the polyvinyl acetal resin in the second layer is in an amount of 100 parts by weight.

According to an embodiment of the present invention, the polyvinyl acetal resin in the second layer has a hydroxyl group content ranging from 25 mol % to 31 mol %.

According to one embodiment of the present invention, the second layer has a glass transition temperature ranging from 25° C. to 35° C.

According to an embodiment of the present invention, the loss factor of the second layer ranges from 0.37 to 0.94.

According to an embodiment of the present invention, the polymer film is a three-layer structure consisting of an upper layer formed by a first said second layer, a lower layer formed by a second said second layer, and one said first layer sandwiched between the upper layer and the lower layer.

According to an embodiment of the present invention, the polymer film has a damping loss factor greater than 0.25 when measured at 20° C. according to ISO 16940: Measurement of the Mechanical Impedance of Laminated Glass.

According to an embodiment of the present invention, the polymer film is used as an intermediate film in laminated glass and has a thickness ranging from 0.5 mm to 2 mm.

According to an embodiment of the present invention, the thickness of the polymer film is 0.8 mm, with the upper layer having a thickness of 0.335 mm, the first layer having a thickness of 0.13 mm, and the lower layer having a thickness of 0.335 mm.

According to an embodiment of the present invention, the polyvinyl acetal is polyvinyl butyral (PVB).

The polymer film provided by the present invention is advantageous in that, based on the features defined herein, the polymer film can produce a good soundproofing effect, and that the polymer film also has a desirable structure and desirable film-forming properties as demonstrated by some preferred embodiments of the invention.

### BRIEF DESCRIPTION OF THE SEVERAL VIEWS OF THE DRAWINGS

The foregoing and other objectives, features, and advantages of the present invention can be better understood by referring to the following detailed description of some illustrative embodiments in conjunction with the accompanying drawings, in which:

FIG. 1 to FIG. 3 are sectional views showing the laminated layers of the polymer films in different embodiments of the invention; and

FIG. 4 is a flowchart of the polymer film manufacturing process in one embodiment of the invention.

In accordance with common practice, the various features and elements in the drawings are not drawn to scale, but are drawn in order to best represent specific features and elements relevant to the present invention. Otherwise, the same or similar reference numerals are used to refer to similar elements and parts among the different drawings.

### DETAILED DESCRIPTION OF THE INVENTION

In order to make the description of the present invention more detailed and complete, the following provides an illustrative description for the implementation aspects and specific embodiments of the present invention, but this is not the only way to implement or use the specific embodiments of the present invention. In this specification and the scope of the appended claims, “a” and “the” may also be construed as plural unless the context dictates otherwise. In addition, within the scope of this specification and the appended patent applications, unless otherwise stated, “disposed on something” can be regarded as directly or indirectly in contact with the surface of something by attachment or other forms. The definition of the surface judgment should be based on the context/paragraph semantics of the description and common knowledge in the field to which this description pertains.

Notwithstanding that the numerical ranges and parameters used to define the invention are approximate numerical values, the numerical values set forth in the specific examples have been presented as precisely as possible. Any numerical value, however, inherently contains the standard deviation resulting from individual testing methods. As used herein, “about” generally means that the actual value is within plus or minus 10%, 5%, 1%, or 0.5% of a particular value or a range. Alternatively, the word “about” means that the actual value lies within an acceptable standard error of the mean, as determined by one of ordinary skill in the art to which this invention pertains. Therefore, unless otherwise stated to the contrary, the numerical parameters disclosed in this specification and the accompanying claims are approximate numerical values and may be changed as required. At a minimum, these numerical parameters should be construed to mean the number of significant digits indicated and the numerical values obtained by applying ordinary rounding.

The present invention provides a polymer film that includes a polyvinyl acetal resin and a plasticizer. More specifically, the polyvinyl acetal resin referred to herein is a resin composition prepared by condensation of polyvinyl alcohol (PVA) with an aldehyde. The PVA may be obtained through saponification of a polyvinyl ester, with the degree of saponification of the PVA generally ranging from 70 mol % to 99.9 mol %, such as 70 mol %, 75 mol %, 80 mol %, 85 mol %, 90 mol %, 95 mol %, 99 mol % or 99.9 mol %. The aldehyde is generally an aldehyde with a carbon number ranging from 1 to 10, such as methanol (also known as formaldehyde), ethanal (also known as acetaldehyde), propanal (also known as propionaldehyde), butanal (also known as butyraldehyde), isobutyraldehyde, pentanal (also known as valeraldehyde), 2-ethylbutyraldehyde, hexanal (also known as caproaldehyde), octanal, nonanal (also known as pelargonaldehyde), decanal (also known as capraldehyde), or benzaldehyde. Preferably, the aldehyde is propionaldehyde, butyraldehyde, isobutyraldehyde, caproaldehyde, or valeraldehyde. More preferably, the aldehyde is propionaldehyde, butyraldehyde, or isobutyraldehyde. In one embodiment of the invention, the polyvinyl acetal is polyvinyl butyral (PVB).

The plasticizer, which is often used in conjunction with a polyvinyl acetal resin to modulate the viscoelasticity of the resulting material, may be selected from the group consisting of a monobasic ester, a polybasic ester, an organic phosphoric acid, and an organic phosphorous acid, without limitation. More specifically, the plasticizer may be selected from the group consisting of triethylene glycol bis(2-ethylhexanoate) (3G0), tetraethylene glycol bis(2-ethylhexanoate), triethylene glycol bis(2-ethylbutanoate), tetraethylene glycol bis(2-ethylbutanoate), triethylene glycol diheptanoate, tetraethylene glycol diheptanoate, dihexyl adipate, dioctyl adipate, hexyl cyclohexyl adipate, diisononyl adipate, heptyl nonyl adipate, dibutyl sebacate, bis[2-(2-butoxyethoxy)ethyl] adipate, polyadipate, propylene glycol dibenzoate, dipropylene glycol dibenzoate, tripropylene glycol dibenzoate, polypropylene glycol dibenzoate, 2,2,4-trimethyl-1,3-pentanediyl dibenzoate, isodecyl benzoate, 2-ethylhexyl benzoate, di-isononyl phthalate, dibutoxy ethyl terephthalate, castor oil, methyl ricinoleate, soybean oil, and epoxidized soybean oil.

The polymer film includes at least one first layer and at least one second layer, and the first layer and the second layer have different loss factors. As used herein, the term “loss factor” refers to the tanδ value (also known as the damping factor or the loss tangent), which indicates one of the viscoelasticity properties, or more specifically the damping characteristic, of a material and is equivalent to the ratio of the loss modulus (G″, also known as the viscosity modulus) to the storage modulus (G′, also known as the elasticity modulus) of the material. The loss factor peaks at a temperature known as the glass transition temperature (Tg). Generally, the loss factor is in direct proportion to the viscosity of the material; a lower glass transition temperature roughly indicates a softer material.

In at least one preferred embodiment, the ratio of the loss factor of the first layer of the polymer film to the loss factor of the second layer ranges from 1.30 to 3.12, such as 1.30, 1.32, 1.46, 1.49, 1.62, 1.75, 1.78, 1.83, 1.87, 1.92, 1.97, 2.31, 2.41, 3.00 or 3.12. In the polymer film provided by the present invention, the loss factor of the first layer ranges from 0.70 to 1.38, such as 0.70, 0.89, 0.94, 0.96, 0.99, 1.17, 1.18, 1.20, 1.21, 1.24, 1.26, 1.28, 1.31 or 1.38; and the loss factor of the second layer ranges from 0.37 to 0.94, such as 0.37, 0.42, 0.46, 0.52, 0.54, 0.61, 0.63, 0.65, 0.67, 0.78 or 0.94.

In addition, in some embodiments of the present invention, the glass transition temperature of the first layer ranges from −7° C. to 6° C., preferably from −6.99° C. to 5.26° C. In some other embodiments of the invention, the glass transition temperature of the second layer ranges from 25° C. to 35° C., preferably from 26.63° C. to 33.19° C.

In the polymer film provided by the present invention, the plasticizer in the first layer is in the amount of 50 to 90 parts by weight while the polyvinyl acetal resin in the first layer is in the amount of 100 parts by weight. More specifically, the plasticizer in the first layer is in the amount of 60 to 90 parts by weight, preferably 60 to 70 parts by weight, such as 60, 61, 62, 63, 64, 65, 66, 67, 68, 69 or 70 parts by weight, while the polyvinyl acetal resin in the first layer is in the amount of 100 parts by weight. In some embodiments of the invention, the plasticizer in the second layer is in the amount of 30 to 60 parts by weight, preferably 37 to 43 parts by weight, such as 37, 38, 39, 40, 41, 42 or 43 parts by weight, while the polyvinyl acetal resin in the second layer is in the amount of 100 parts by weight.

Without being limited by any specific theories, the hydroxyl group content of a polyvinyl acetal resin is regarded as related to plasticizer compatibility. As used herein, the term “hydroxyl group content” of a polyvinyl acetal resin refers to a mole faction calculated by dividing the amount of ethylene bonded to the hydroxyl groups by the total amount of ethylene on the carbon backbone and multiplying the quotient by 100%. In the polymer film provided by the present invention, the polyvinyl acetal resin in the first layer has a hydroxyl group content greater than 15.0 mol % and less than 30.6 mol %, preferably greater than 16.0 mol % and less than 30.6 mol %, more preferably ranging from 16.4 mol % to 30.0 mol %, such as 16.4, 19.2, 22.6, 23.3, 23.8, 24.7, 25.0, 25.1, 25.7, 29.3 or 30.0 mol %. In some embodiments of the invention, the polyvinyl acetal resin in the second layer has a hydroxyl group content ranging from 25 mol % to 31 mol %, preferably from 27.4 mol % to 30.8 mol %, such as 27.4, 27.5, 27.6, 27.7, 27.9, 28.1, 28.3, 28.4, 29.6 or 30.8 mol %.

As used herein, the term “degree of acetalization” of a polyvinyl acetal resin refers to a mole faction calculated by dividing the amount of ethylene bonded to the acetal groups by the total amount of ethylene on the carbon backbone and multiplying the quotient by 100%.

As used herein, the term “degree of acetylation” of a polyvinyl acetal resin refers to a mole fraction calculated by subtracting the amount of ethylene bonded to the hydroxyl groups and the amount of ethylene bonded to the acetal groups from the total amount of ethylene on the carbon backbone, dividing the difference by the total amount of ethylene on the carbon backbone, and multiplying the quotient by 100%. In the polymer film provided by the present invention, the polyvinyl acetal resin in the first layer has a degree of acetylation less than 20 mol %, preferably ranging from 8.0 mol % to 11.8 mol %, such as 8.0, 8.2, 8.5, 9.2, 9.6, 10.1, 10.2, 10.5, 11.5, 11.8 mol %.

The hydroxyl group content, the degree of acetalization, and the degree of acetylation are calculated according to test results obtained by JIS K6728 “Testing Methods for Polyvinyl Butyral”.

In the polymer film provided by the present invention, the polyvinyl acetal resin in the first layer has a bulk density ranging from 0.220 to 0.280, preferably from 0.248 to 0.258. The bulk density is determined according to JIS K6720.

As used herein, the term “degree of polymerization” is an indicator of the size of a polymer molecule. Based on the number of repeated units, the degree of polymerization of a polymer is the average of the numbers of repeated units on the macromolecular chains. In the polymer film provided by the present invention, the polyvinyl acetal resin in the first layer has a degree of polymerization greater than 1600 and less than 3850, preferably greater than 1750 and less than 3850, more preferably ranging from 2000 to 3700, such as 2000, 2200, 2400, 2600, 2800, 3000, 3200, 3400, 3500, 3600 or 3700.

As used herein, the term “loss factor” refers specifically to the damping loss factor, whose value is regarded as in direct proportion to the soundproofing effect. The damping loss factor of the polymer film provided by the present invention is greater than 0.25 when measured at 20° C. according to ISO 16940: Measurement of the Mechanical Impedance (MIM) of Laminated Glass.

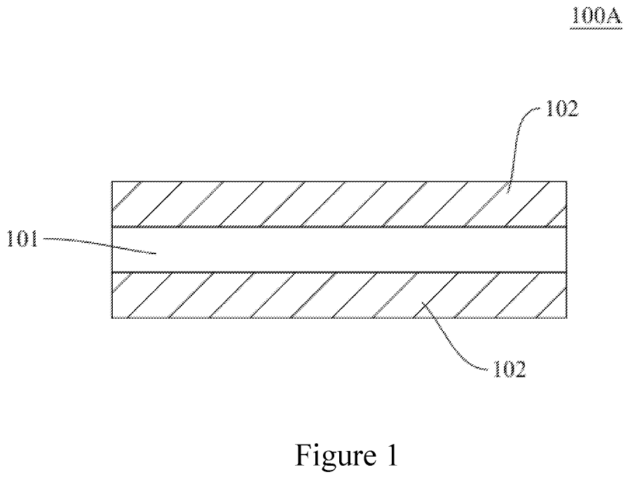

FIG. 1 to FIG. 3 are sectional views showing the laminated layers of the polymer films in different embodiments of the present invention. The polymer films in those embodiments are different in structure. FIG. 1 is a sectional view showing the laminated layers of the polymer film 100A in one embodiment of the invention. As shown in FIG. 1, the polymer film 100A is a three-layer structure in which both the upper and the lower layers are second layers 102, and in which a first layer 101 lies between the two second layers 102. In some embodiments of the invention, the polymer film 100A can be used as an intermediate film in laminated glass by being provided between two sheets of glass, with the first layer 101 serving as an interlayer, and the second layers 102 serving as protective layers. As to thickness, the polymer film 100A has a thickness ranging from 0.5 mm to 2 mm, such as 0.5, 0.6, 0.7, 0.8, 0.9, 1.0, 1.1, 1.2, 1.3, 1.4, 1.5, 1.6, 1.7, 1.8, 1.9 or 2.0 mm. Preferably, the thickness of the polymer film 100A is 0.8 mm, with the thickness of the first layer 101 ranging from 0.11 mm to 0.15 mm, preferably being 0.13 mm, and the thickness of each second layer 102 ranging from 0.320 mm to 0.350 mm, preferably being 0.335 mm.

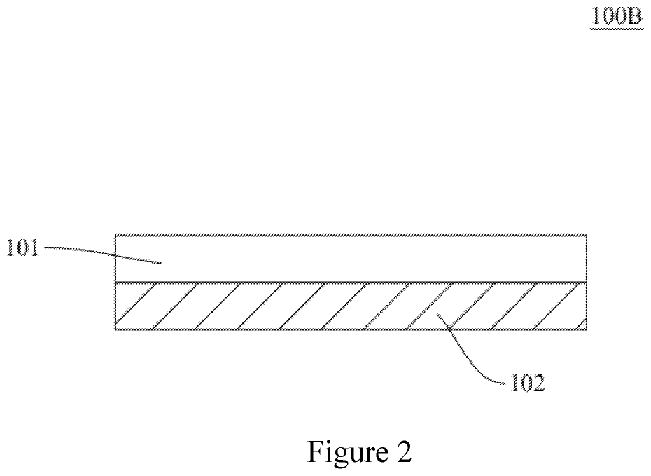

FIG. 2 is a sectional view showing the laminated layers of the polymer film 100B in one embodiment of the present invention. The polymer film 100B is similar to the polymer film 100A in the previous embodiment, the difference being that the polymer film 100B is a double-layer structure formed by laminating a first layer 101 and a second layer 102 together.

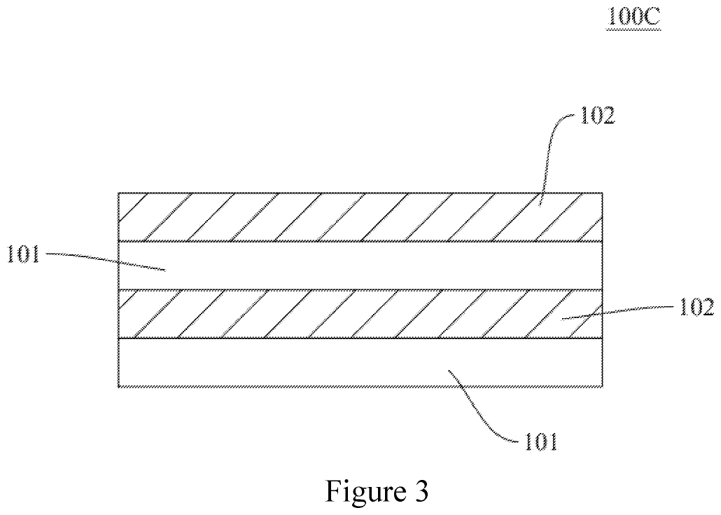

FIG. 3 is a sectional view showing the laminated layers of the polymer film 100C in one embodiment of the present invention. The polymer film 100C is similar to the polymer film 100A, the difference being that the polymer film 100C includes an additional first layer 101 bonded to the upper or the lower second layer 102. Apart from the embodiments described above, a person of ordinary skill in the art may add at least one first layer 101 or second layer 102 to the polymer film 100C in an alternating manner so as to form a five-layer, six-layer, or more-than-six-layer structure as needed, without departing from the concept of the invention.

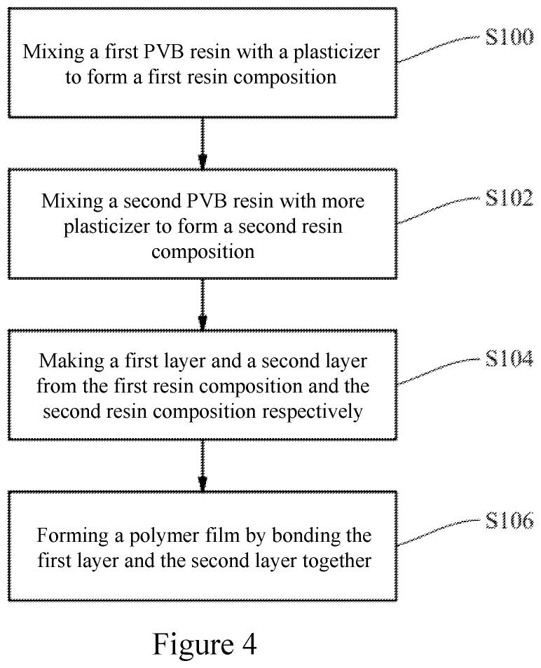

FIG. 4 is a flowchart of the polymer film manufacturing process in one embodiment of the present invention. As shown in FIG. 4, the polymer film manufacturing process of the invention at least includes steps S100 to S106. More specifically, step S100 involves mixing a first PVB resin with a plasticizer to form a first resin composition, wherein the operation temperature and rotation speed of the mixing process can be adjusted according to conventional methods and practical needs; the invention has no limitation on the details of the process conditions. In step S102, a second PVB resin is mixed with more plasticizer to form a second resin composition, wherein the operation temperature and rotation speed of the mixing process can be adjusted according to conventional methods and practical needs; the invention has no limitation on the details of the process conditions, either. In step S104, the first resin composition and the second resin composition are made into a first layer and a second layer respectively, wherein the method for making the layers may be a conventional film preparation method such as extrusion or thermoforming. In step S106, the first layer and the second layer are bonded together to form a polymer film, wherein the bonding method may also be a conventional film preparation method such as extrusion or thermoforming.

The polymer film made by the foregoing manufacturing process may serve as a to-be-tested film and be subjected to the following property tests.

Determination of Viscoelasticity

The method used for the determination of viscoelasticity at least includes the following steps: First, a to-be-tested film is cut into a circle with a diameter of 8 mm, and the circular to-be-tested film is put into a thermo-hygrostat for 24 hours, during which the temperature and relative humidity of the thermo-hygrostat are kept at 23° C. and 55% respectively. After that, the to-be-tested film is placed in a rotational shear rheometer (Discovery Hybrid Rheometer (DHR) II, manufactured by TA Instrument) in order to carry out viscoelasticity analysis by the oscillation method, wherein the analysis conditions are: the test temperature being lowered from 100° C. to −10° C. at a temperature reduction rate of 3° C./min, the oscillation frequency being set at 1 Hz, the strain of the film under test being kept at 1%, and the fixture pressure being set at 1 N. The loss factor and glass transition temperature of the film under test are derived from the analysis result.

Determination of Leakage from the Interlayer of a Film

One indicator of the structural integrity of a multilayer film (or more particularly a film with at least three layers so that an interlayer can be defined) and of the compatibility of the film with a plasticizer is whether the interlayer of the film leaks. The same is also one of the factors that determine the soundproofing effect of the multilayer film.

If a to-be-tested film is determined to have shown leakage from the interlayer of the film, it can be inferred that the interlayer has relatively low compatibility with the plasticizer used therein, and that the film has relatively low uniformity. The method used for the determination of leakage from the interlayer of a film at least includes the following steps: First, a to-be-tested film is cut into a 4 cm circle, and the circular film is put into a thermo-hygrostat for 48 hours, during which the temperature and relative humidity of the thermo-hygrostat are kept at 23° C. and 55% respectively. After that, a normal force of 8 N is applied to the to-be-tested film for 10 seconds, at the end of which the interlayer is immediately observed with the naked eye to see if it leaks.

Determination of How Well a Film is Formed

Another indicator of the structural integrity of a multilayer film (or more particularly a film with at least three layers so that an interlayer can be defined) and of the compatibility of the film with a plasticizer is how well the film is formed. The same is also one of the factors that determine the soundproofing effect of the multilayer film. If the plasticizer in the interlayer of a multilayer film leaks out after the hot-pressing process of the film, and the film is not properly formed as a result, it can be inferred that the interlayer has relatively low compatibility with the plasticizer. The method used for the determination of how well a film is formed includes making the polymer film of the present invention by thermoforming, and then immediately observing with the naked eye if any unabsorbed plasticizer leaks from the interlayer of the film.

Determination of the Loss Factor

The method used to determine the loss factor is based on ISO 16940: Measurement of the Mechanical Impedance (MIM) of Laminated Glass. More specifically, the method at least includes the following steps: First, a to-be-tested film is sandwiched between two pieces of clean, transparent float glass each having a length of 300 mm, a width of 25 mm, and a thickness of 2 mm. Next, a pre-pressing process is performed, followed by an autoclave process to complete the preparation of a piece of laminated glass (the pre-pressing process conditions including pre-pressing with a hot press at 150° C. for 3 minutes, and the autoclave process conditions including pressing at 135° C. and with a pressure of 13 bar for 120 minutes). On the 14^{th} day after the completion of its preparation, the laminated glass is placed in a thermo-hygrostat for 2 hours, during which the temperature and relative humidity of the thermo-hygrostat are regulated so as to stay at 23° C. and 55% respectively. The center of the laminated glass is then secured on a vibration shaker, before the laminated glass is vibrated at an ambient temperature of 20° C. The force and frequency of the vibrations are measured with an impedance head, and the experiment data is converted by an analysis system into the loss factor. It should be pointed out that the loss factor is based on the first vibration mode calculated by the half-power method, and that it is generally believed that the greater the value of the loss factor, the better the soundproofing effect. For example, the value of the loss factor being greater than 0.25 at 20° C. indicates that the polymer film has a good soundproofing effect.

Embodiments 1 to 15

The polymer films in embodiments 1 to 15 of the present invention were provided according to the foregoing contents and were made with different parameters so as to have different properties respectively. The polymer films (which may also be referred to as intermediate films) were then analyzed in terms of how well the films were formed, of leakage from the interlayer of each film, and of their loss factors. Regarding how well an intermediate film was formed, an intermediate film was determined as properly formed and was indicated by “0” if no plasticizer leakage had occurred, and an intermediate film was determined as not properly formed and was indicated by “X” if plasticizer leakage had occurred.

It should be pointed out that embodiments 1 through 15 used a three-layer structure in which the second layer in the present invention was provided as each of the upper and the lower protective layers while the first layer in the invention was provided as the interlayer.

The preparation method of the polymer films in embodiments 1 to 15 is briefly described as follows:

To begin with, 100 parts by weight of a first PVB resin and 60 to 90 parts by weight of a plasticizer (triethylene glycol bis(2-ethylhexanoate)) were sufficiently mixed in a mixer to produce a resin composition for use in the interlayer, and 100 parts by weight of a second PVB resin and 37 to 43 parts by weight of the same plasticizer (triethylene glycol bis(2-ethylhexanoate)) were sufficiently mixed in a mixer to produce a resin composition for use in the protective layers.

Next, the resin composition for use in the interlayer and the resin composition for use in the protective layers were separately hot-pressed at 150 ° C. with a hot press to form the protective layers (thickness of each layer: 0.335 mm) and the interlayer (thickness: 0.13 mm).

Lastly, the interlayer was placed between the two protective layers to form a three-layer structure, and this structure was pre-hot-pressed with a hot press at 100° C. for 1 minute and then hot-pressed at 150° C. for 3 minutes to produce an intermediate film with a three-layer structure (thickness: 0.8 mm).

The parameters and the property analysis results of embodiments 1 to 15 are detailed in Table 1.

TABLE 1

| | | | | Embod- | Embod- | Embod- | Embod- | Embod- | Embod- | Embod- | Embod- |
|---|---|---|---|---|---|---|---|---|---|---|---|
| | | | Unit | iment 1 | iment 2 | iment 3 | iment 4 | iment 5 | iment 6 | iment 7 | iment 8 |
| Interlayer | PVB resin | Solid content of | wt % | 14 | 14 | 14 | 14 | 14 | 14 | 14 | 14 |
| | | PVA for use in | | | | | | | | | |
| | | synthesis | | | | | | | | | |
| | | Bulk density | | 0.258 | 0.249 | 0.248 | 0.258 | 0.248 | 0.251 | 0.258 | 0.249 |
| | | Degree of | | 2400 | 3500 | 3400 | 2200 | 2800 | 3000 | 2600 | 3200 |
| | | polymerization | | | | | | | | | |
| | | Hydroxyl group | mol % | 22.6 | 25.7 | 25.1 | 19.2 | 23.8 | 24.7 | 23.3 | 25.0 |
| | | content | | | | | | | | | |
| | | Degree of | mol % | 8.0 | 9.2 | 9.6 | 10.5 | 8.2 | 11.5 | 11.8 | 9.6 |
| | | acetylation | | | | | | | | | |
| | | Degree of | mol % | 69.4 | 65.1 | 63.3 | 70.3 | 68.0 | 63.8 | 64.9 | 65.4 |
| | | acetalization | | | | | | | | | |
| | Plasticizer | Content | phr | 66 | 63 | 64 | 68 | 65 | 65 | 65 | 64 |
| | Loss factor | | | 1.24 | 0.94 | 0.96 | 1.26 | 1.20 | 1.18 | 1.21 | 0.99 |
| | Glass transition | | ° C. | −1.44 | 2.83 | 3.32 | 1.84 | −6.99 | 0.76 | 2.61 | 5.26 |
| | temperature | | | | | | | | | | |
| Protective | PVB resin | Solid content of | wt % | 14 | 14 | 14 | 14 | 14 | 14 | 14 | 14 |
| layers | | PVA for use in | | | | | | | | | |
| | | synthesis | | | | | | | | | |
| | | Bulk density | | 0.253 | 0.258 | 0.253 | 0.258 | 0.249 | 0.258 | 0.253 | 0.248 |
| | | Degree of | | 1800 | 1800 | 1800 | 1800 | 1800 | 1800 | 1800 | 1800 |
| | | polymerization | | | | | | | | | |
| | | Hydroxyl group | mol % | 27.7 | 28.4 | 28.1 | 27.5 | 27.4 | 28.1 | 27.7 | 28.4 |
| | | content | | | | | | | | | |
| | | Degree of | mol % | 1.0 | 1.0 | 1.0 | 1.0 | 1.0 | 1.0 | 1.0 | 1.0 |
| | | acetylation | | | | | | | | | |
| | | Degree of | mol % | 71.3 | 70.6 | 70.9 | 71.5 | 71.6 | 70.9 | 71.3 | 70.6 |
| | | acetalization | | | | | | | | | |
| | Plasticizer | Content | phr | 40 | 40 | 40 | 40 | 40 | 40 | 40 | 40 |

| | | | | | | | | | |
|---|---|---|---|---|---|---|---|---|---|
| Loss factor | | 0.94 | 0.63 | 0.54 | 0.78 | 0.52 | 0.63 | 0.63 | 0.54 |
| Glass transition | ° C. | 33.19 | 30.96 | 29.19 | 28.43 | 3094 | 30.12 | 29.72 | 30.18 |
| temperature | | | | | | | | | |

| | | | | | | | | |
|---|---|---|---|---|---|---|---|---|
| Ratio of interlayer loss factor to | 1.32 | 1.49 | 1.78 | 1.62 | 2.31 | 1.87 | 1.92 | 1.83 |
| protective-layer loss factor | | | | | | | | |
| Loss factor | 0.263 | 0.266 | 0.275 | 0.272 | 0.296 | 0.284 | 0.286 | 0.281 |
| Leakage from interlayer | No | No | No | No | No | No | No | No |
| Proper film formation | ◯ | ◯ | ◯ | ◯ | ◯ | ◯ | ◯ | ◯ |

| | | | | Embod- | Embodi- | Embodi- | Embodi- | Embodi- | Embodi- | Embodi- |
|---|---|---|---|---|---|---|---|---|---|---|
| | | | Unit | iment 9 | ment 10 | ment 11 | ment 12 | ment 13 | ment 14 | ment 15 |
| Interlayer | PVB resin | Solid content of | wt % | 14 | 14 | 14 | 14 | 14 | 14 | 14 |
| | | PVA for use in | | | | | | | | |
| | | synthesis | | | | | | | | |
| | | Bulk density | | 0.253 | 0.257 | 0.253 | 0.253 | 0.253 | 0.251 | 0.252 |
| | | Degree of | | 3600 | 3700 | 2000 | 3600 | 1600 | 1700 | 1750 |
| | | polymerization | | | | | | | | |
| | | Hydroxyl group | mol % | 29.3 | 30.0 | 16.4 | 29.3 | 15.2 | 15.5 | 15.8 |
| | | content | | | | | | | | |
| | | Degree of | mol % | 10.1 | 8.5 | 10.2 | 8.2 | 11.5 | 10.2 | 8.2 |
| | | acetylation | | | | | | | | |
| | | Degree of | mol % | 60.6 | 61.5 | 73.4 | 62.5 | 73.3 | 74.3 | 76.0 |
| | | acetalization | | | | | | | | |
| | Plasticizer | Content | phr | 61 | 60 | 70 | 61 | 90 | 80 | 70 |
| | Loss factor | | | 0.89 | 0.70 | 1.38 | 0.89 | 1.31 | 1.28 | 1.17 |
| | Glass transition | | ° C. | −3.35 | −0.79 | −1.63 | −3.35 | −3.27 | −2.18 | −1.62 |
| | temperature | | | | | | | | | |
| Protective | PVB resin | Solid content of | wt % | 14 | 14 | 14 | 14 | 14 | 14 | 14 |
| layers | | PVA for use in | | | | | | | | |
| | | synthesis | | | | | | | | |
| | | Bulk density | | 0.256 | 0.256 | 0.253 | 0.256 | 0.248 | 0.253 | 0.254 |
| | | Degree of | | 1800 | 1800 | 1800 | 1800 | 1800 | 1800 | 1800 |
| | | polymerization | | | | | | | | |
| | | Hydroxyl group | mol % | 28.3 | 27.9 | 27.4 | 29.6 | 27.6 | 27.7 | 30.8 |
| | | content | | | | | | | | |
| | | Degree of | mol % | 1.0 | 1.0 | 1.0 | 1.0 | 1.0 | 1.0 | 1.0 |
| | | acetylation | | | | | | | | |
| | | Degree of | mol % | 70.7 | 71.1 | 71.6 | 69.4 | 71.4 | 71.3 | 68.2 |
| | | acetalization | | | | | | | | |
| | Plasticizer | Content | phr | 40 | 40 | 40 | 40 | 40 | 40 | 40 |

| | | | | | | | | |
|---|---|---|---|---|---|---|---|---|
| Loss factor | | 0.37 | 0.54 | 0.46 | 0.61 | 0.42 | 0.65 | 0.67 |
| Glass transition | ° C. | 31.42 | 30.22 | 29.87 | 30.27 | 26.93 | 26.63 | 28.72 |
| temperature | | | | | | | | |

| | | | | | | | |
|---|---|---|---|---|---|---|---|
| Ratio of interlayer loss factor to | 2.41 | 1.30 | 3.00 | 1.46 | 3.12 | 1.97 | 1.75 |
| protective-layer loss factor | | | | | | | |
| Loss factor | 0.301 | 0.258 | 0.323 | 0.263 | 0.332 | 0.289 | 0.272 |
| Leakage from interlayer | No | No | No | No | Yes | Yes | Yes |
| Proper film formation | ◯ | ◯ | ◯ | ◯ | X | X | X |

As shown in Table 1, the ratio of the interlayer loss factor to the protective-layer loss factor of each of embodiments 1 to 15 ranged from 1.30 to 3.12, which indicates that the films in all those embodiments had desirable loss factors. Furthermore, as shown by embodiments 1 to 12, in which there was neither leakage from the interlayers nor failure in film formation, the interlayer PVB resin having a hydroxyl group content greater than 16.0 mol % and less than 30.6 mol % led to high plasticizer compatibility.

Comparative Examples 1 to 5

The polymer films (which may also be referred to as intermediate films) in comparative examples 1 to 5 were provided by a preparation method similar to that used for embodiments 1 to 15 (the differences can be known by comparing Table 2 with Table 1), and were subsequently analyzed in terms of how well the films were formed, of leakage from the interlayer of each film, and of their loss factors. The analysis and evaluation methods were the same as those used for embodiments 1 to 15.

It should be pointed out that comparative examples 1 through 5 used a three-layer structure consisting of an upper protective layer, a lower protective layer, and an interlayer provided between the two protective layers. The parameters and the property analysis results of comparative examples 1 to 5 are detailed in Table 2.

TABLE 2

| | | | | Comparative | Comparative | Comparative | Comparative | Comparative |
|---|---|---|---|---|---|---|---|---|
| | | | Unit | example 1 | example 2 | example 3 | example 4 | example 5 |
| Interlayer | PVB resin | Solid content of PVA | wt % | 14 | 14 | 14 | 14 | 14 |
| | | for use in synthesis | | | | | | |
| | | Bulk density | | 0.251 | 0.258 | 0.249 | 0.258 | 0.248 |
| | | Degree of | | 3875 | 3850 | 3900 | 4000 | 3950 |
| | | polymerization | | | | | | |
| | | Hydroxyl group | mol % | 30.9 | 30.6 | 31.1 | 31.3 | 31.2 |
| | | content | | | | | | |
| | | Degree of acetylation | mol % | 9.6 | 10.5 | 8.2 | 11.8 | 8.5 |
| | | Degree of | mol % | 59.5 | 58.9 | 60.7 | 56.9 | 60.3 |
| | | acetalization | | | | | | |
| | Plasticizer | Content | phr | 51 | 53 | 49 | 45 | 47 |
| | Loss factor | | | 0.81 | 0.84 | 0.80 | 0.78 | 0.79 |
| | Glass transitiont emperature | | ° C. | 0.91 | −0.88 | 1.27 | 1.33 | 2.48 |
| Protective | PVB resin | Solid content of PVA | wt % | 14 | 14 | 14 | 14 | 14 |
| layers | | for use in synthesis | | | | | | |
| | | Bulk density | | 0.249 | 0.258 | 0.253 | 0.256 | 0.256 |
| | | Degree of | | 1800 | 1800 | 1800 | 1800 | 1800 |
| | | polymerization | | | | | | |
| | | Hydroxyl group | mol % | 28.0 | 28.0 | 27.6 | 28.3 | 28.3 |
| | | content | | | | | | |
| | | Degree of acetylation | mol % | 1.0 | 1.0 | 1.0 | 1.0 | 1.0 |
| | | Degree of | mol % | 71.0 | 71.0 | 71.4 | 70.7 | 70.7 |
| | | acetalization | | | | | | |
| | Plasticizer | Content | phr | 40 | 40 | 40 | 40 | 40 |

| | | | | | | |
|---|---|---|---|---|---|---|
| Loss factor | | 0.63 | 0.66 | 0.73 | 0.77 | 0.65 |
| Glass transition temperature | ° C. | 27.84 | 27.42 | 26.61 | 26.94 | 25.63 |

| | | | | | |
|---|---|---|---|---|---|
| Ratio of interlayer loss factor to | 1.29 | 1.27 | 1.10 | 1.01 | 1.22 |
| protective-layer loss factor | | | | | |
| Loss factor | 0.224 | 0.219 | 0.211 | 0.201 | 0.214 |
| Leakage from interlayer | No | No | No | No | No |
| Proper film formation | ◯ | ◯ | ◯ | ◯ | ◯ |

As shown in Table 2, the ratio of the interlayer loss factor to the protective-layer loss factor of each of comparative examples 1 to 5 was less than 1.30, and the loss factors of the polymer films in all the comparative examples were relatively small, both of which jointly indicate that the polymer films in the comparative examples had an undesirable soundproofing effect.

According to the above, the present invention provides a polymer film particularly suitable for use as an intermediate film in laminated glass. The ratio of the loss factor (tanδ) of the first layer of the polymer film to the loss factor of the second layer ranges from 1.30 to 3.12 such that a piece of laminated glass using the polymer film as an intermediate film has a desirable soundproofing effect. Furthermore, the polymer film has good film-forming properties when its hydroxyl group content is greater than 16.0 mol % and less than 30.6 mol %.

The above is the detailed description of the present invention, but the above is merely the preferred embodiments of the present invention, and should not limit the scope of implementation of the present invention, that is, all equivalent changes and modifications according to the scope of the patent application of the present invention should still fall within the scope of the patent of the present invention.

1. A polymer film, comprising a polyvinyl acetal resin and a plasticizer; wherein:
the polymer film comprises at least one first layer and at least one second layer, and the first layer has a loss factor different from a loss factor of the second layer; and
a ratio of the loss factor of the first layer to the loss factor of the second layer ranges from 1.30 to 3.12.

2. The polymer film of claim 1, wherein the plasticizer in the first layer is in an amount of 50 to 90 parts by weight while the polyvinyl acetal resin in the first layer is in an amount of 100 parts by weight.

3. The polymer film of claim 2, wherein the polyvinyl acetal resin in the first layer has a hydroxyl group content greater than 16.0 mol % and less than 30.6 mol %.

4. The polymer film of claim 3, wherein the polyvinyl acetal resin in the first layer has a degree of polymerization greater than 1750 and less than 3850.

5. The polymer film of claim 4, wherein the polyvinyl acetal resin in the first layer has a degree of acetylation less than 20 mol %.

6. The polymer film of claim 5, wherein the first layer has a glass transition temperature ranging from −7° C. to 6° C.

7. The polymer film of claim 6, wherein the loss factor of the first layer ranges from 0.70 to 1.38.

8. The polymer film of any of claim 7, wherein the plasticizer in the second layer is in an amount of 30 to 60 parts by weight while the polyvinyl acetal resin in the second layer is in an amount of 100 parts by weight.

9. The polymer film of claim 8, wherein the polyvinyl acetal resin in the second layer has a hydroxyl group content ranging from 25 mol % to 31 mol %.

10. The polymer film of claim 9, wherein the second layer has a glass transition temperature ranging from 25° C. to 35° C.

11. The polymer film of claim 10, wherein the loss factor of the second layer ranges from 0.37 to 0.94.

12. The polymer film of claim 11, wherein the polymer film is a three-layer structure consisting of an upper layer formed by a first said second layer, a lower layer formed by a second said second layer, and one said first layer sandwiched between the upper layer and the lower layer.

13. The polymer film of claim 11, wherein the polymer film has a damping loss factor greater than 0.25 when measured at 20° C. according to ISO 16940: Measurement of the Mechanical Impedance of Laminated Glass.

14. The polymer film of claim 11, wherein the polymer film is used as an intermediate film in laminated glass and has a thickness ranging from 0.5 mm to 2 mm.

15. The polymer film of claim 12 14, wherein the thickness of the polymer film is 0.8 mm, with the upper layer having a thickness of 0.335 mm, the first layer having a thickness of 0.13 mm, and the lower layer having a thickness of 0.335 mm.

16. The polymer film of claim 15, wherein the polyvinyl acetal is polyvinyl butyral (PVB).
